(19) United States
(12) Patent Application Publication
(10) Pub. No.: US 2025/0200224 A1
(43) Pub. Date: Jun. 19, 2025

(54) DATA STREAM AUDITING, NOTIFICATION, COMPLIANCE MONITORING, AND TRANSFORMATION

(71) Applicant: Wells Fargo Bank, N.A., San Francisco, CA (US)

(72) Inventors: Jeremy Daniel Blackburn, Tempe, AZ (US); Justin Christopher Blackburn, Gallatin Gateway, MT (US); Jacob Tyler Blackburn, Phoenix, AZ (US); Christina Marie Delia, Waxhaw, NC (US)

(21) Appl. No.: 17/304,802

(22) Filed: Jun. 25, 2021

(51) Int. Cl. G06F 21/62; G06F 16/2455; G06N 20/00; H04L 9/40

(52) U.S. Cl. CPC G06F 21/6263; G06F 21/6245; H04L 63/0245

(57) ABSTRACT

Systems and techniques for data stream auditing, notification, compliance monitoring, and transformation are described herein. A data stream may be subscribed to and data may be collected from the data stream. The data may be collected by polling the data stream at a polling frequency. Sensitive data may be identified in the collected data as an audit event. Audit event data may be generated. The audit event data may be stored in an audit results data structure. A notification of the audit event may be transmitted to an owner of the data stream.

### TECHNICAL FIELD

Embodiments described herein generally relate to data stream auditing and, in some embodiments, more specifically to auditing data streams, monitoring data stream compliance, generating data stream compliance notifications, and transforming data streams to meet compliance requirements.

### BACKGROUND

Data may be presented as data streams rather than traditional transactional messaging busses. Streaming architecture enables the use of microservices, but presents challenges at scale. Streams may operate on a publisher and subscriber model where messages are published to a stream and systems subscribe to the stream to retrieve data. At scale, hundreds of terabytes or even petabytes of data may flow through these streams. An organization may wish to audit the stream to determine where data originated, whether the data contains sensitive data such as Personally Identifiable Information (PII) or confidential data, and who is potentially consuming the sensitive data.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for data stream auditing, notification, compliance monitoring, and transformation, according to an embodiment.

FIG. 2 illustrates a block diagram of an example of a publisher/subscriber data streaming infrastructure for Data Stream Auditing, Notification, Compliance Monitoring, and Transformation, according to an embodiment.

FIG. 3 illustrates a block diagram of an example of silent subscription and polling of a data stream for data stream auditing, notification, compliance monitoring, and transformation, according to an embodiment.

FIG. 4 illustrates a flow diagram of an example of a method for silent subscription and polling of a data stream for data stream auditing, notification, compliance monitoring, and transformation, according to an embodiment.

FIG. 5 illustrates a block diagram of an example of automated data stream polling interval adjustment for data stream auditing, notification, compliance monitoring, and transformation, according to an embodiment.

FIG. 6 illustrates a flow diagram of an example of a method for automated data stream polling interval adjustment for data stream auditing, notification, compliance monitoring, and transformation, according to an embodiment.

FIG. 7 illustrates a block diagram of an example of automated pattern matching for data stream auditing, notification, compliance monitoring, and transformation, according to an embodiment.

FIG. 8 illustrates a flow diagram of an example of a method for automated pattern matching for data stream auditing, notification, compliance monitoring, and transformation, according to an embodiment.

FIG. 9 illustrates a block diagram of an example of automated data stream transformation for data stream auditing, notification, compliance monitoring, and transformation, according to an embodiment.

FIG. 10 illustrates a flow diagram of an example of a method for automated data stream transformation for data stream auditing, notification, compliance monitoring, and transformation, according to an embodiment.

FIG. 11 illustrates a block diagram of an example of audit event enrichment for data stream auditing, notification, compliance monitoring, and transformation, according to an embodiment.

FIG. 12 illustrates a flow diagram of an example of a method for audit event enrichment for data stream auditing, notification, compliance monitoring, and transformation, according to an embodiment.

FIG. 13 illustrates a flow diagram of an example of a method for data stream auditing, notification, compliance monitoring, and transformation, according to an embodiment.

FIG. 14 is a block diagram illustrating an example of a machine upon which one or more embodiments may be implemented.

### DETAILED DESCRIPTION

Many organizations distribute data as data streams rather than as traditional transactional messaging busses (e.g., Mule, RabbitMQ, etc.). This streaming architecture enables the use of microservices but presents challenges at scale. Data stream systems (e.g., Apache KAFKA®, etc.) work on a publisher/subscriber model meaning messages are published to a stream and systems subscribe to the stream to retrieve data. At scale, hundreds of terabytes or even petabytes of data may flow through these streams.

Effectively auditing the data to determine where it originated, whether it contains sensitive data such as Personally Identifiable Information (PII) or confidential data, and who is potentially consuming that sensitive data is a challenge in data streams. The systems and techniques discussed herein solve the issue of auditing data streams by enabling silent subscription to streams, sampling the data to identify patterns that match PII and other sensitive data, reporting the audit findings to a storage system, and connecting to a configuration management database (CMDB) to notify the publisher/subscriber. Artificial intelligence and machine learning are used to evaluate the audited data set in order to reduce false positives and to learn new patterns for more effectively identifying PII in the future.

Data is moving from traditional queue systems (e.g., IBM® MQ, Mule, RabbitMQ, etc.) to new data systems that use near real-time event streaming architectures (e.g., Apache KAFKA®, AMAZON® Web Services (AWS) Kinesis, etc.). Data streaming architecture enables the use of microservices. At scale, hundreds of terabytes or even petabytes of data may flow through these streams. Tracking dissemination of data may be important to ensure data privacy and to meet compliance regulations. The systems and techniques discussed herein enable auditing for issues involving PII and for message format compliance. The ability to automate auditing is important because the volume of data is massive in a data intensive organization. The number of data streams is constantly changing making it improbable (if not impossible) that the entirety of the data streams could be manually audited at all times. Conventional data auditing techniques may be enabled manually by an administrator and the volume and changing nature of dynamic data streams make it impractical to manage the auditing infrastructure which may lead to auditing failures for data that has not been configured for auditing or when the data stream configurations change and the configuration is no longer effectively auditing the data.

The systems and techniques discussed herein detects PII or other compliance issues, determines where the PII or compliance issue originated, determines whether it actually contains sensitive data such as PII or confidential data, determines who created the data or is responsible to creating the data (e.g., the source, the publisher, etc.), and who is potentially consuming that sensitive data (e.g., the consumer, the subscriber, etc.). An automated remediation/transformation engine scrubs (e.g., removes confidential data, PII, etc.) data and publishes the scrubbed data to a new data stream. Source and destination servers are automatically remediated and the remediation steps are automatically documented. For example, it may be determined that a data stream includes PII and a subscriber should not have access to the PII. A transformed data stream is generated that does not include the PII and the subscriber is redirected to the transformed data stream preventing the subscriber from receiving the PII. This functionality prevents developers from having to immediately recode applications that may have subscribers with different levels of access to secure data by splitting the stream into the original stream with PII for subscribers that have a need or security clearance to the PII and a transformed stream that is provided to subscribers that do not need the PII or do not have security clearance for the PII.

Detected compliance or auditing issues should be addressed by the data owner so that confidential information is provided only to systems that have a need and clearance to receive the confidential data. Thus, an automated notification. ticket is created and transmitted to a team responsible for the data stream. It may be understood that a variety of automated notification techniques may be used to notify the responsible party such as, email, text message, system message, application message, etc.

An audit engine includes a variety of components that may use a variety of technologies and may be implemented as microservices. The audit engine may include a sampler that reads from the data streams, a polling manager that adjusts polling intervals and polls the data streams, an analyzer that searches for patterns in the samples from the streams, a transformation Engine that removes PII when found and re-publishes scrubbed data to a new data stream, a storage medium that stores audit results, a reporting engine that reports audit results, and a machine learning platform that analyzes curated results for false positives and improves detection algorithms used by the analyzer.

Conventional techniques may be used to monitor event streaming software, however there is no effective mechanism to audit the data itself in a scalable fashion. Conventional techniques do not poll data stream data. Unlike conventional monitoring techniques, the systems and techniques discussed herein poll the data by randomly sampling the data of a data stream. Sampling is an effective way to audit compliance in that audits need not be constant and continuous to be effective. Sampling may be conducted at random or may be coordinated. For example, the sampling may be timed based on the criticality of the data and how often PII occurs in the data stream. In an example, a new data stream may be sampled randomly until a sampling baseline has been established at which time the sampling may become coordinated based on the PII or other sensitive data detected in the data stream. In addition, due to the volume of both data and streams, the processing all of the data may overwhelm the computing systems monitoring the data and may be cost prohibitive based on the computing resources needed to prevent the computing systems from being overwhelmed. Furthermore, the polling system auto-tunes itself. The polling reflects the importance of the data. Analyzing the results of the criticality of the data contained in the stream, etc., allows for iterative improvement of the polling and sampling feature as more data is processed. This results in continuous improvement in audit event detection over time. Pattern matching, artificial intelligence (AI) and machine learning (ML) are used to evaluate the data streams and PII to provide a feedback mechanism and to transform outputs where a new data stream is generated to address an audit event.

There may be specific regulations regarding sensitive data that are to be followed during transport of data. Streaming technology presents numerous challenges due to data volume and the publisher/subscriber model. It also presents new opportunities for data flow between components. The systems and techniques discussed herein keep PII compartmentalized to the components that need them. A feedback loop is created to eliminate PII at the source so that compliance is maintained eliminating the problem of inadvertent release of sensitive data.

The systems and techniques discussed herein are applicable to infrastructures using data streaming technologies and could be applied to systems that transport data such as message queuing (MQ) software; extract, transform, load (ETL) processes; databases; caching software; etc.

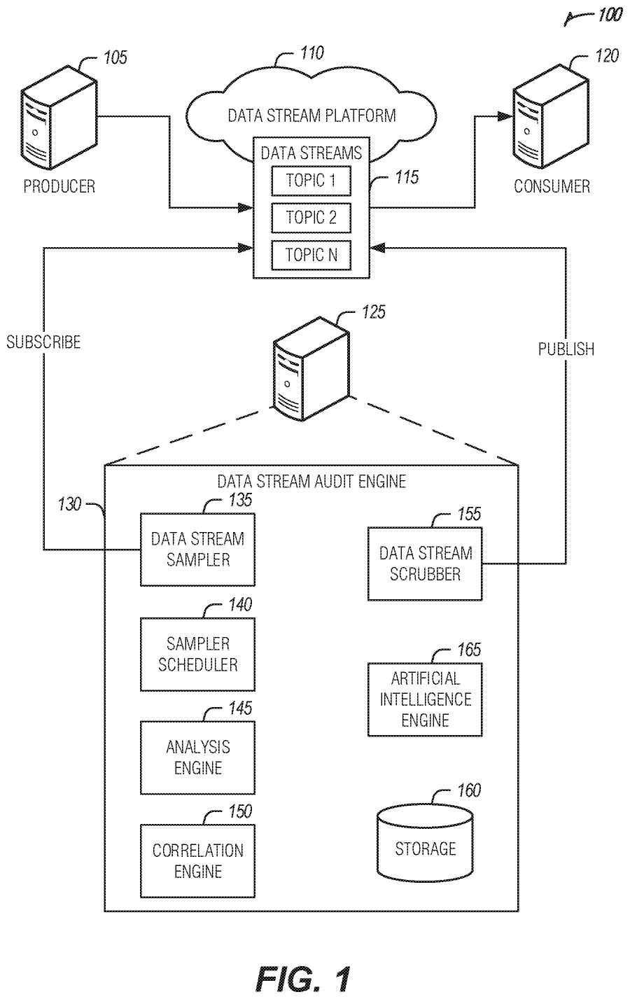

FIG. 1 is a block diagram of an example of an environment 100 and a system 130 for data stream auditing, notification, compliance monitoring, and transformation, according to an embodiment. The environment may include a data producer 105 that may publish a data stream to data streams 115 of a data stream platform 110, a data consumer 120 that may subscribe to the data stream published by the producer 105, and a data stream auditing service 125. In an example, the data stream auditing service may be a microservice, a standalone server, a server cluster, a cloud service platform, an application appliance, or other computing system or platform. The data producer 105, the data stream platform 110, the data consumer 120, and the data stream auditing service 125 may be communicatively coupled via a wired network, a wireless network, a cellular network, a shared bus, etc.

The data stream auditing service 125 may include the system 130. In an example, the system 130 is a data stream audit engine. In an example, the system 130 may be software stored in memory of the data stream auditing service 125 and executed by at least one processor of the data stream auditing service 125. In another example, the data stream auditing service 125 may be an application specific integrated circuit (ASIC), a field-programmable gate array (FPGA), a system on chip (SoC), or other hardware device in which the system 130 or components of the system 130 may be implemented.

The system 130 may include a variety of components including a data stream sampler 135, a sampler scheduler 140, an analysis engine 145, a correlation engine 150, a data stream scrubber 155, storage 160, and an artificial intelligence engine 165. The data stream sampler 135, the sampler scheduler 140, the analysis engine 145, the correlation engine 150, the data stream scrubber 155, storage 160, and the artificial intelligence engine 165 may be implemented in a single computing device, multiple computing devices, or distributed singly or in various combinations on a variety of computing devices such as the data stream auditing service 125.

The data stream sampler 135 silently subscribes to the data stream and collects data from the data stream. The data is collected by polling the data stream at a polling frequency. In an example, the data stream is subscribed to silently without interfering with the data consumer 120 of the data stream. The sampler scheduler 140 sets or modifies the polling frequency based on available computing resources, criticality of data included in the data stream, volume of data, number of data streams, etc. In an example, the sampler scheduler 140 determines a criticality value for the data stream and adjusts the polling frequency based on the criticality value.

The analysis engine 145 identifies sensitive data in the collected data as an audit event and generated audit event data. In an example, the analysis engine 145 obtains a data detection pattern from a data detection pattern data source and evaluates the collected data using the data detection pattern. The sensitive data is identified based on a match between the collected data and the data detection pattern. The data stream sampler 135 stores the audit event data in an audit results data structure in the storage 160 and transmits a notification of the audit event to an owner of the data stream. In an example, the notification includes an identity of the data stream, remediation steps, and a type of the audit event.

The correlation engine 150 establishes a connection to one or more of a configuration management database, a firewall log, and a data stream platform log. An enhanced audit event entry is generated that includes the audit event data and correlated data from the configuration management database, the firewall log, and the data stream platform log. The enhanced audit event entry is stored in the audit results data structure. The owner of the data stream may be determined using the enhanced audit event entry.

The data stream scrubber 155 generated a new data stream by removing the sensitive data from the data stream and publishing the new data stream to a data stream platform. The data stream scrubber 155 may work in conjunction with the data stream sampler 135 and correlation engine 150 to identify the data consumer 120 for the data stream and redirect the data consumer 120 to the new data stream. For example, the social security numbers or other sensitive data may be removed from the data stream and published as a second data stream that has been scrubbed of sensitive data. The data consumer 120 may be redirected to the new scrubbed data stream to prevent inadvertent release of sensitive data.

The artificial intelligence engine 165 evaluates the enhanced audit event entry using an artificial intelligence processor and refines a data detection pattern or the polling frequency based on the evaluation. In an example, the artificial intelligence engine 165 may receive feedback in response to the notification transmitted to the owner of the data stream and may evaluate the response in combination with the enhanced audit event entry to learn to reduce false positive detection, improve criticality calculation, and improve polling frequency adjustment. The artificial intelligence engine 165 works in conjunction with the sampler scheduler 140, the analysis engine 145, and other components of the system 130 to improve algorithms used to set polling frequency, detect violations, calculate criticality, correlate data, etc.

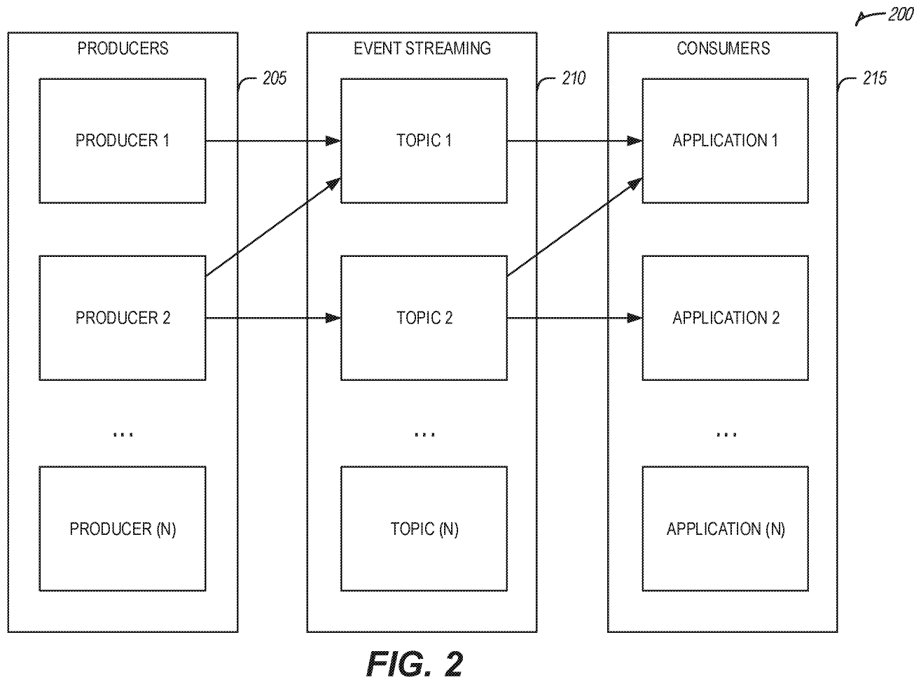

FIG. 2 illustrates a block diagram of an example of a publisher/subscriber data streaming infrastructure 200 for Data Stream Auditing, Notification, Compliance Monitoring, and Transformation, according to an embodiment. Streams work on a publish/subscribe model. Messages are published to streams 210 (e.g., topics) by producer systems 205. Producer systems 205 that are authenticated publish messages to the streams 210. Consumer systems 215 subscribe to the streams 210. The consumer systems 215 retrieve data from the subscribed streams 210. The producer systems 205 may publish to multiple streams 210 and consumer systems 215 may read from multiple streams.

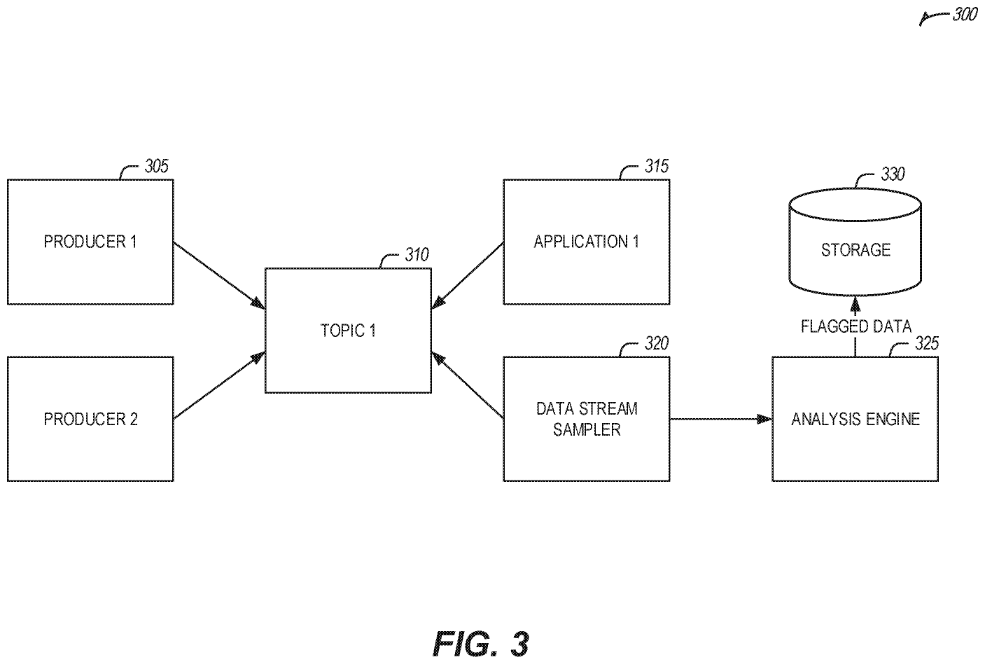

FIG. 3 illustrates a block diagram of an example of silent subscription and polling of a data stream 300 for data stream auditing, notification, compliance monitoring, and transformation, according to an embodiment.

A producer 305 may publish data to a data stream 310. A consuming application 315 may subscribe to the data stream 310 to consume data from the data stream 310. A data stream sampler 320 may silently (e.g., without notification, intervention, and/or interference, etc.) subscribe to the data stream 310. The data stream sampler 320 may sample the data using polling that collects a representative amount of data from the data stream 310. The representative data includes enough data at a frequency that ensures that there is no PII or confidential data present and message standards are met. The data stream sampler 320 silently subscribes to the data stream 310 and consumes without interrupting flow of data to other applications such as consuming application 315. The data stream sampler 320 passes the collected data to an analysis engine 325 that analyzes the collected data to determine if there is an audit event present in the data. For example, it may be determined that there PII or other sensitive data present that should not be present in the data or that compliance regulations are not being met by the data stream 310. If an audit event is detected, the flagged data and other audit event data may be transmitted to storage 330.

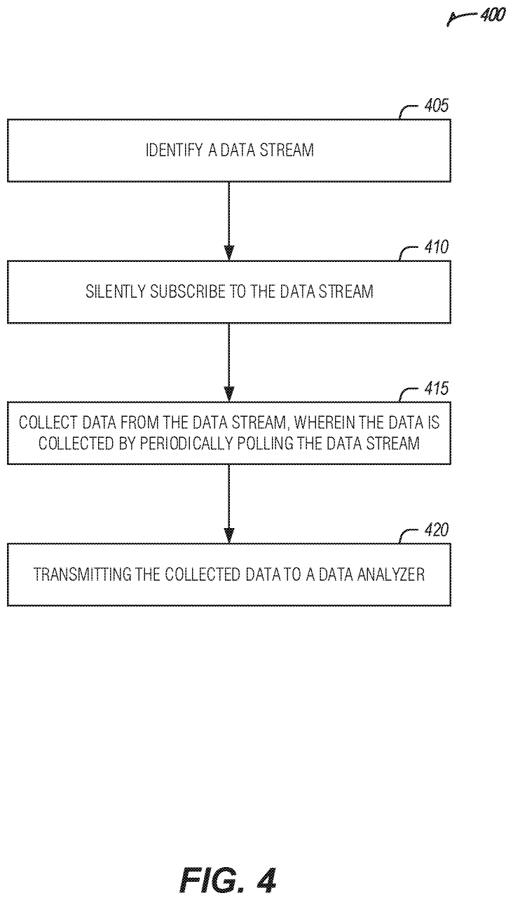

FIG. 4 illustrates a flow diagram of an example of a method 400 for silent subscription and polling of a data stream for data stream auditing, notification, compliance monitoring, and transformation, according to an embodiment. The method 400 may provide features as described in FIGS. 1-3.

At operation 405, a data stream is identified. In an example, the data stream is a new data stream added to a data stream platform. In another example, the data stream is a reconfigured data stream of the data stream platform.

At operation 410, a request to silently subscribe to the data stream may be transmitted to the data stream platform and a silent subscription may be authorized for the data stream. The silent subscription prevents alteration or interference with the data stream for other subscribers. In an example, the silent subscription is a probe or monitoring entry point to the data stream that includes read only access to the data stream.

At operation 415, data is collected from the data stream by periodically polling the data stream. In an example, the frequency of the polling may be adjusted automatically based on a probability calculation of the sensitivity of the data included in the data stream and/or a calculated probability that the data stream includes noncompliant content. In an example, the collected data is a subset of the data present in the data stream. In an example, a sample size may be determined for the subset based on an input value for a data model used to identify noncompliant content of the data stream.

At operation 420, the collected data is transmitted to a data analyzer. In an example, the collected data is stored in a storage data structure that enables access to a set of collected data for the data analyzer.

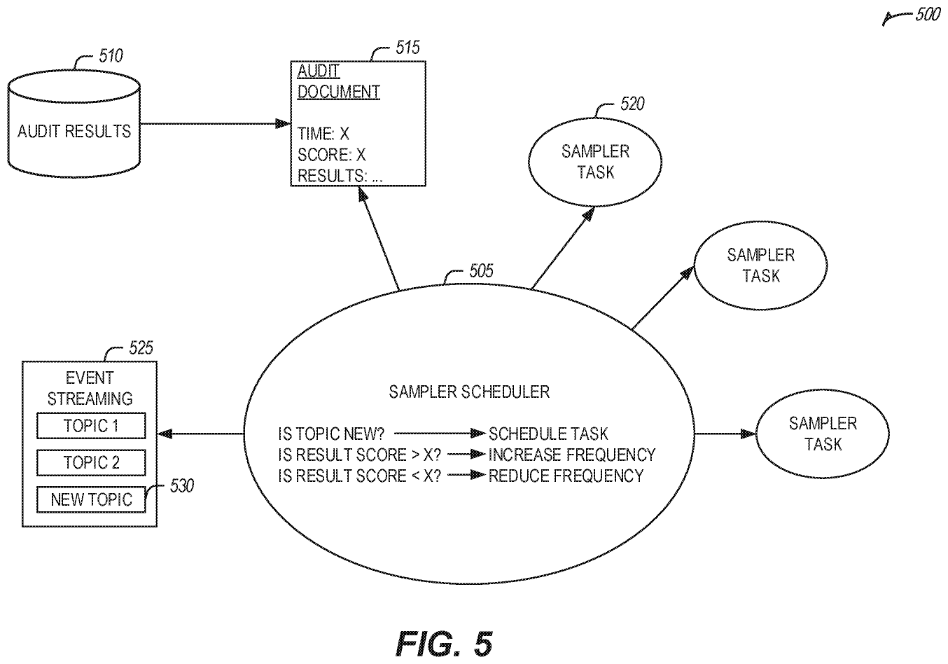

FIG. 5 illustrates a block diagram of an example of automated data stream polling interval adjustment 500 for data stream auditing, notification, compliance monitoring, and transformation, according to an embodiment.

A sampler scheduler 505 may adjusts the polling interval to more or less frequent sampling based on audit results 510 determined by a data analysis engine (e.g., the analysis engine 325 as described in FIG. 3, etc.). The sample scheduler 505 evaluates audit documents 515 from the audit results 510 to optimize polling frequency based on capabilities of the audit/polling system (e.g., CPU, memory, storage, bandwidth, etc.), the criticality of the data, the volume of data flow, and the number of streams. Criticality of the data describes how important the audit is and the kind of data in the stream. In an example, the criticality may be referenced as a factor (e.g., rated from 1-10, etc.).

The sampler scheduler 505 evaluates available system resources (e.g., capability), criticality, data volume, and number of streams and calculates a polling frequency for the data streams. In other examples, a subset of available system resources (e.g., capability), criticality, data volume, and number of streams may be used to calculate a polling frequency. The frequency is included in a sampler task 520 for the data stream. The sampler scheduler 505 automatically scans for new data streams 530 in the data streams 525 and creates a new sampler task 520 and adjusts sampling intervals for existing sampler tasks when new streams are discovered. The sampler scheduler 505 continuously adjusts the sampling rates based on system resources, criticality, data volume, and number of streams to prevent the computing systems from becoming overloaded while focusing sampling on data streams that have a higher probability of including noncompliant content based on the previous audit results 510.

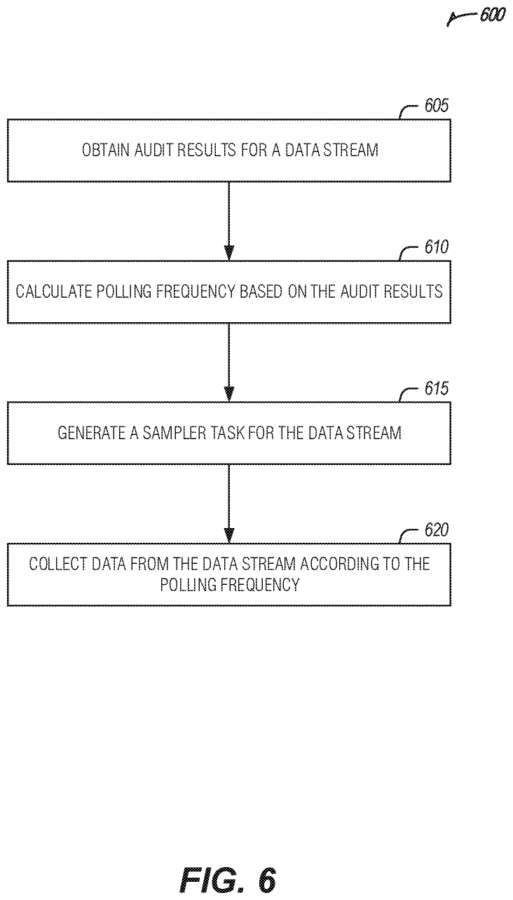

FIG. 6 illustrates a flow diagram of an example of a method 600 for automated data stream polling interval adjustment for data stream auditing, notification, compliance monitoring, and transformation, according to an embodiment. The method 600 may provide features as described in FIGS. 1-5.

At operation 605, audit results are obtained for a data stream. For example, a data stream sampler (e.g., the data stream sampler 320 as described in FIG. 3, etc.) may collect data from the data stream and an analysis engine (e.g., the analysis engine 325 as described in FIG. 3, etc.) may evaluate the collected data to determine compliance or noncompliance of content of the data stream to generate the audit results.

At operation 610, a polling frequency is calculated for the data stream based on the audit results. In an example, a criticality value may be calculated for the data stream and/or the data of the data stream, computing capacity may be determined for the data stream sampler(s), a volume of data may be determined, and a number of data streams may be determined. In an example, the criticality value, computing capacity, data volume, and number of streams may be evaluated to calculate the polling frequency. In an example, the criticality is determined in part based on the audit results.

At operation 615, a sampler task is generated for the data stream using the polling frequency. For example, a data stream with low criticality (e.g., criticality of 1-3 on a 1-10 scale, etc.) may be assigned a polling frequency of two minutes meaning data collection will occur at two minute intervals. A data stream with high criticality (e.g., criticality of 8-10 on a 1-10 scale, etc.) may be assigned a polling frequency of thirty seconds meaning data collection will occur at thirty second intervals. The intervals may be adjusted up or down based on the total volume of data to be collected, available system resources, the number of data streams from which data is to be collected, etc. However, the sampler tasks are configured proportionally based on the criticality to ensure that the most critical data streams receive the highest monitoring frequency. For example, high criticality data streams may maintain a frequency of thirty seconds while the frequency of low criticality data streams may be adjusted to five minutes. Thus, more resources are allocated to high criticality data streams and less resources are allocated to low criticality data streams.

At operation 620, the sampler task may be transmitted to the data stream sampler and data may be collected from the data stream according to the polling frequency.

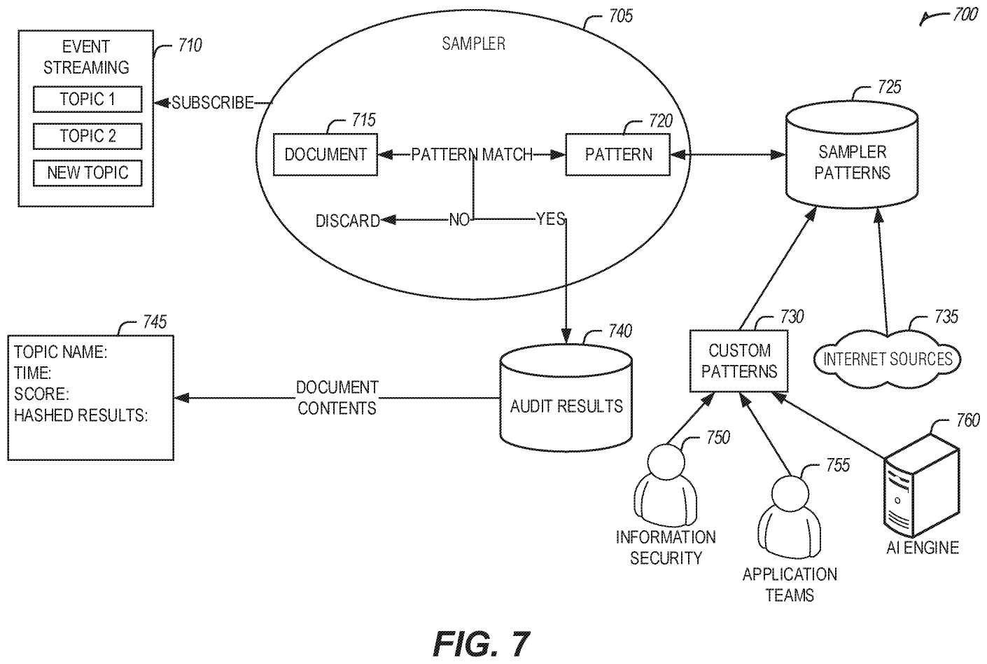

FIG. 7 illustrates a block diagram of an example of automated pattern matching 700 for data stream auditing, notification, compliance monitoring, and transformation, according to an embodiment.

A data sampler (e.g., the data sampler 320 as described in FIG. 3, etc.) looks for patterns that match PII and other sensitive data in documents 715 and other content of a data stream 710 against a pattern 720 from a dynamic sampler pattern database 725 of custom patterns 730 for PII and confidential data that are created by information security personnel 750, application teams 755, an artificial intelligence engine 760, etc. The sampler pattern database 725 may also include patterns provided from other sources such as, by way of example, and not limitation, internet sources 735.

If the data sampler 705 does not determine a pattern match, the data is discarded. If the data sampler 705 determines a pattern match, the data and detection result is added to an audit results database 740. An audit event 745 is generated in the audit results database 745 that includes document contents a data stream name, time of collection/detection, a score for the audit event (e.g., a criticality score, etc.), hashed results, etc. The results may include the PII or other sensitive data so they may be hashed to protect the data from further inadvertent release.

The artificial intelligence engine 760 uses artificial intelligence and machine learning to evaluate the audit results combined with feedback from a notification process to reduce false positives and learn new patterns to fine tune the pattern matching function. As more data and feedback is received, the artificial intelligence engine 760 continues to fine tune the patterns resulting in increasing pattern matching efficacy over time. The notification process generates notifications for transmission to data stream owners and receives responses to the notifications. The responses are fed into the artificial intelligence as feedback to learn false positives and to refine PII and sensitive data detection models for pattern matching.

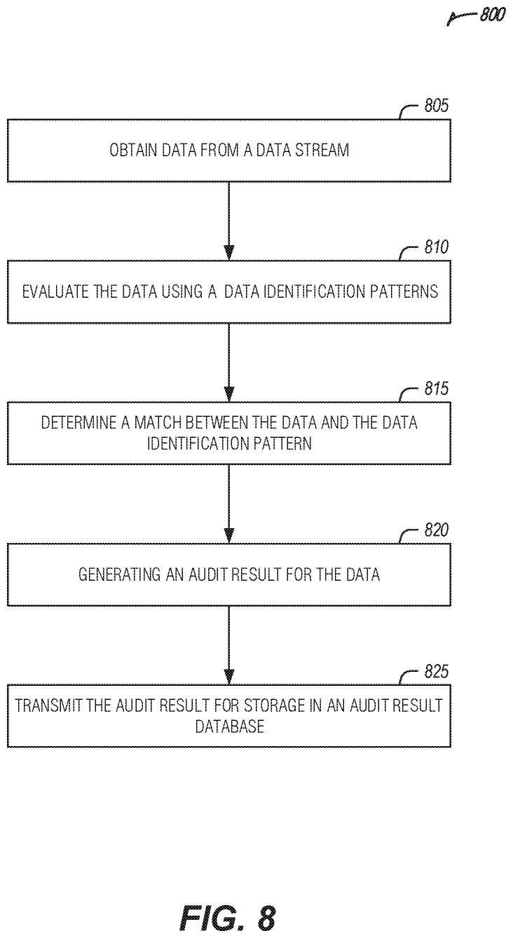

FIG. 8 illustrates a flow diagram of an example of a method 800 for automated pattern matching for data stream auditing, notification, compliance monitoring, and transformation, according to an embodiment. The method 800 may provide features as described in FIGS. 1-7.

At operation 805, data is obtained from a data stream (e.g., by the data sampler 320 as described in FIG. 3, etc.). For example, an application document may be obtained from an application processing data stream that includes application data for bank account applications.

At operation 810, the data may be evaluated using data identification patterns. For example, the text, metadata, file names, and other information included in the application document may be evaluated against a pattern (or a set of patterns) that include characteristics of PII or other sensitive data.

At operation 815, a match may be determined between the data and the data identification pattern. For example, a pattern for a social security number may be evaluated against the application document and it may be determined that a string of text in the application document matches the pattern for a social security number.

At operation 820, an audit result may be generated for the data. For example, an audit result for the application document may indicate the line of text that matches the social security number pattern; a time the application document was collected; a hashed version of the text string; a criticality score calculated based on a criticality value for the pattern, how strong the match probability is calculated to be, etc.; and other information that may be useful for providing notification to a data owner to be used as feedback or training data for an artificial intelligence engine in refining the pattern matching algorithms.

At operation 825, the audit result may be transmitted for storage in an audit result database. The audit result database may include audit events that may be accessed by the artificial intelligence engine to fine tune the patterns or pattern matching algorithms of the data sampler.

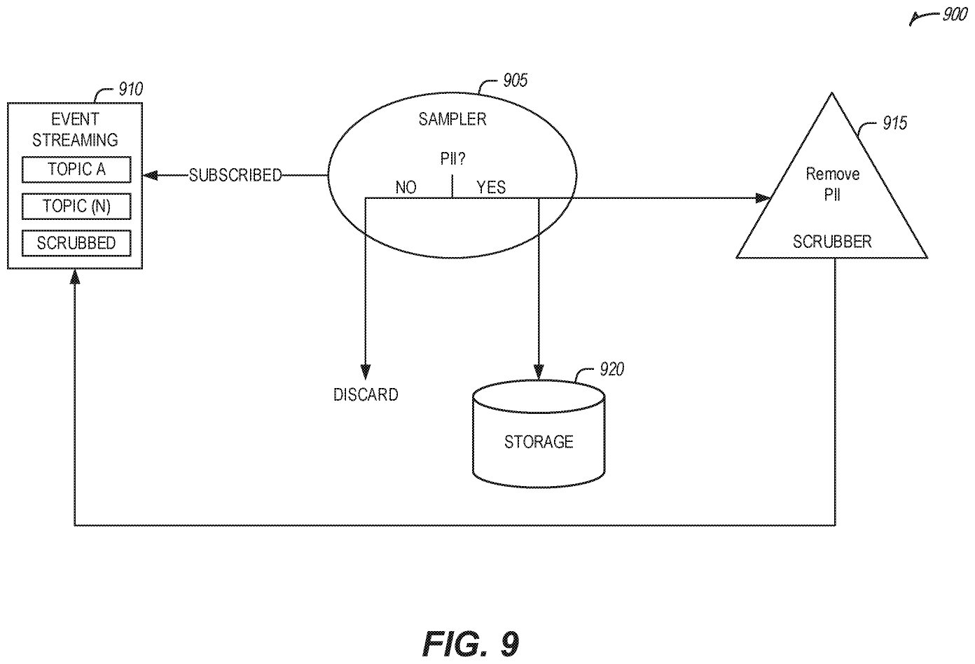

FIG. 9 illustrates a block diagram of an example of automated data stream transformation 900 for data stream auditing, notification, compliance monitoring, and transformation, according to an embodiment.

A data sampler 905 (e.g., the data sampler 320 as described in FIG. 3, etc.) determines if there is PII or other sensitive data present in a data stream 910 and, if so, automatically creates a transformation pipeline(s) to a data stream scrubber 915. The data stream scrubber 915 removes, hashes, or otherwise protects PII and other sensitive data. The data stream scrubber 915 publishes the scrubbed data to a new scrubbed data stream to the data streams 910 for consumers that should not receive the PII. This ensures that consumers do not consume PII if they do not need the PII while maintaining the PII in the original data stream for consumers that have a need for/access to the PII. This allows for remediation at the consumer level giving producers time to remove PII from their stream if it is there erroneously. As previously described in FIG. 7, the data sampler 905 stores the detected audit events in audit results storage 920. Data that is collected by the data sampler 905 that does not include an audit event is not processed and may be discarded, ignored, etc.

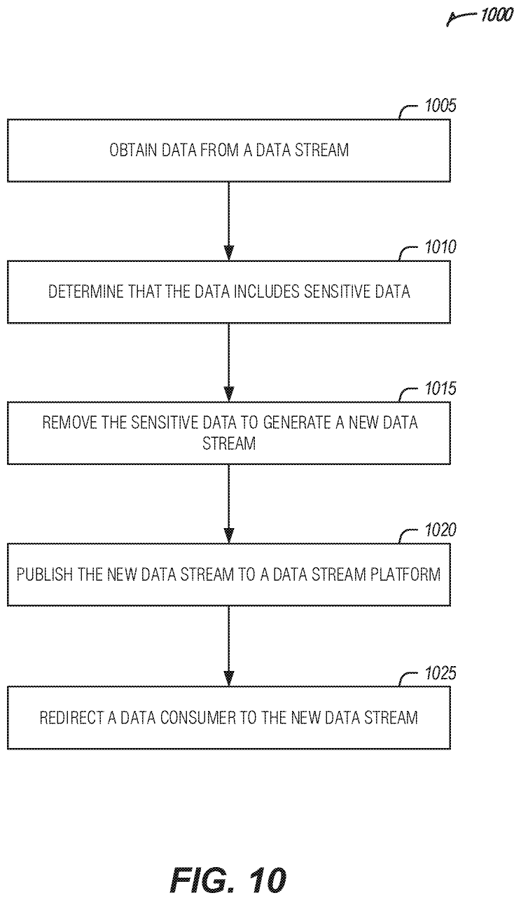

FIG. 10 illustrates a flow diagram of an example of a method 1000 for automated data stream transformation for data stream auditing, notification, compliance monitoring, and transformation, according to an embodiment. The method 1000 may provide features as described in FIGS. 1-9.

At operation 1005, data is obtained (e.g., by the data sampler 320 as described in FIG. 3, etc.) from a data stream. At operation 1010, the data is evaluated to determine if the data includes sensitive data. At operation 1015, the sensitive data is removed (e.g., by the data stream scrubber 915 as described in FIG. 9, etc.) from the data stream to generate a new data stream. For example, the data stream may have included social security numbers of customers in application documents and the new data stream may include the application documents without the social security numbers. At operation 1020, the new data stream is published to a data stream platform. The new data stream may be published with the original data stream so that data consumers that may have a need for the social security numbers (e.g., a bank application processing application service, etc.) still have access to the sensitive data. At operation 1025, a data consumer may be directed to the new data stream. For example, a bank application analytics service may not need access to the social security numbers and may be redirected to the new data stream preventing inadvertent release of customer social security numbers if the bank analytic service is compromised.

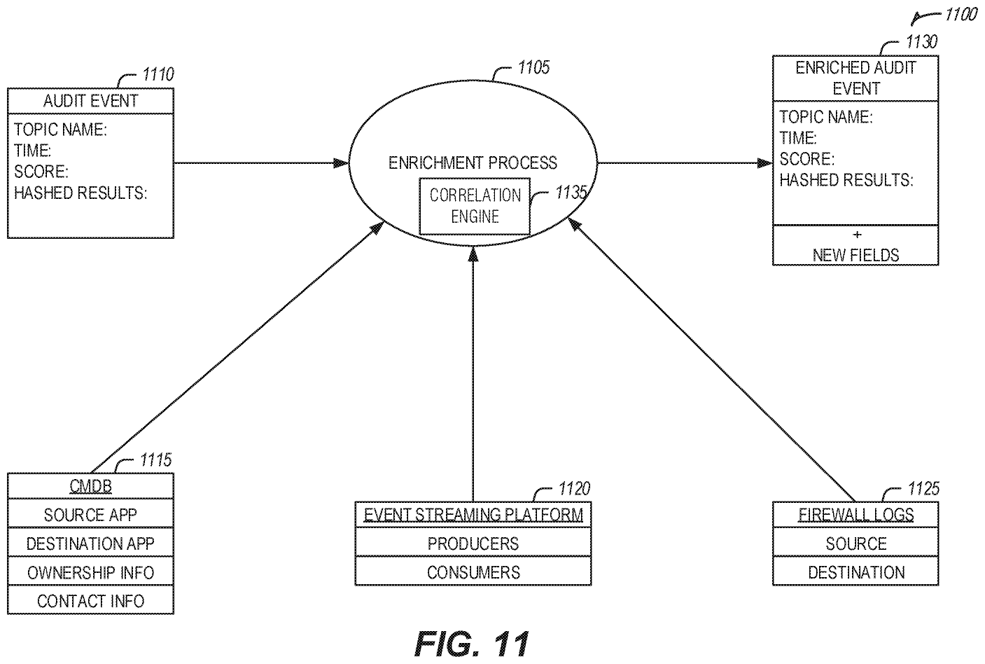

FIG. 11 illustrates a block diagram of an example of audit event enrichment 1100 for data stream auditing, notification, compliance monitoring, and transformation, according to an embodiment.

An enrichment process 1105 receives audit events 1110 and enhances the audit events with information from a configuration management database 1115, an event streaming platform 1120, firewall logs 1125, etc. The enrichment process 1105 reports the enriched audit events 1130 to a storage system. The enhancements may include information correlated to the audit events by a correlation engine 1135 of the enrichment process 1105 from logs of the event streaming platform 1120, the configuration management database 1115, and the firewall 1125. For example, producer(s) and consumer(s) that correspond to an audit event 1110 from event streaming platform 1120, computing endpoints the correspond with the audit event 1110 from the firewall logs 1125, and application and owner information that corresponds to the audit event 1110 from the configuration management database 1115 may be included in the enriched audit event 1130. The enriched audit event 1130 may include a variety of data that may be indexed and searchable including application consuming/producing the data stream, type of PII violation, control policy/procedure/rule that the PII violates, a knowledge base entry, an encrypted/hashed copy of the PII, etc.

The correlation engine 1135 connects to the configuration management database 1115 to determine the application owners for the upstream application that created the PII or confidential data and notifies them they are creating confidential data. The correlation engine 1135 automatically notifies producers/consumers of violation and remediation to be completed at a producer and/or a consumer tier. The notification may include an indication of availability of a new scrubbed stream created as described in FIG. 9. The enrichment process 1105 may scan message format to ensure it is compliant with message standards (e.g., format, structure, tags, other metadata identifiers, etc.) and may include message standard violations in the notifications provided to the producer(s)/consumer(s).

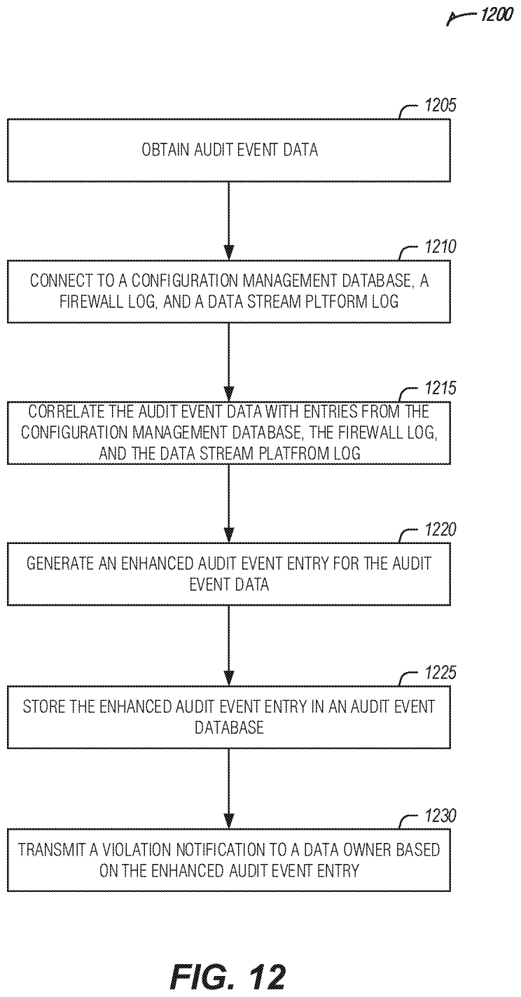

FIG. 12 illustrates a flow diagram of an example of a method 1200 for audit event enrichment for data stream auditing, notification, compliance monitoring, and transformation, according to an embodiment. The method 1200 may provide features as described in FIGS. 1-11.

At operation 1205, audit event data may be obtained by a correlation engine (e.g., the correlation engine 1135 as described in FIG. 11, etc.). At operation 1210, a connection may be established to a configuration management database, a firewall log, and a data stream platform log. At operation 1215, the audit event data may be correlated with entries from the configuration management database, the firewall log, and the data stream platform log. For example, a producer and consumer may be obtained for the audit event data from the data stream platform logs, a data owner and application instance for the audit event data may be obtained from the configuration management database, and producer and consumer endpoints may be obtained from the firewall log. The obtained data may be correlated with the audit event data based on an identifier for a data stream that was the source of the audit event data or based on another identifying characteristic shared by the audit event data and data elements from the configuration management database, the firewall log, and the data stream platform log.

At operation 1220, an enhanced audit event entry may be generated for the audit event data. For example, the obtained data elements from the configuration management database, the firewall log, and the data stream platform log may be combined with the audit event data to generate the enhanced audit event entry. At operation 1225, the enhanced audit event entry may be stored in an audit event database. The enhanced audit event entries in the audit event database may be accessed by an artificial intelligence engine or other data analytics service to generate patterns based on the enhanced audit event data, generate polling frequencies for data streams associated with the enhanced audit event entries, etc. For example, the artificial intelligence engine may evaluate the enhanced audit event entries to identify that an application team has a high number of compliance violations and polling frequency for data streams owned by the application team may be increased to more closely monitor the data streams for violations.

At operation 1230, a violation notification may be transmitted to a data owner based on the enhanced audit event entry. For example, a notification may be transmitted to members of the application team with data streams that violate the compliance policies that includes an identification of the data streams in violation, the data that violates the compliance policy, identification of a new scrubbed data stream automatically generated without the violating data, etc. The notification may include a response mechanism that enables a member of the application team to respond to the notification to indicate if the detection of a violation is valid, whether the violation has been remediated, a reason for the violation, etc. The response received may be used as feedback provided back to the artificial intelligence engine to refine the violation detection patterns and algorithms or to adjust polling frequencies.

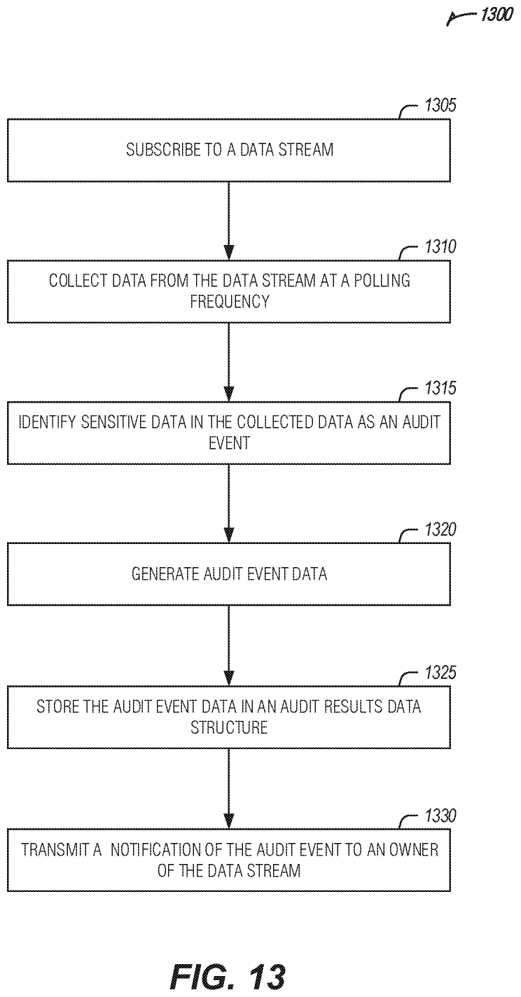

FIG. 13 illustrates a flow diagram of an example of a method 1300 for data stream auditing, notification, compliance monitoring, and transformation, according to an embodiment. The method 1300 may provide features as described in FIGS. 1-12.

At operation 1305, a data stream subscription is established (e.g., by the data stream sampler 135 as described in FIG. 1, etc.). At operation 1310, data is collected from the data stream. The data is collected by polling the data stream at a polling frequency. In an example, the data stream is subscribed to silently without interfering with a data consumer of the data stream. In an example, the polling frequency may be set or modified (e.g., by the sampler scheduler 140 as described in FIG. 1, etc.) based on available computing resources, criticality of data included in the data stream, volume of data, number of data streams, etc. In an example, a criticality value may be determined for the data stream and the polling frequency may be adjusted based on the criticality value.

At operation 1315, sensitive data may be identified (e.g., by the analysis engine 145 as described in FIG. 1, etc.) in the collected data as an audit event. At operation 1320, generated audit event data is generated. In an example, a data detection pattern may be obtained from a data detection pattern data source and the collected data may be evaluated using the data detection pattern. In an example, the sensitive data is identified based on a match between the collected data and the data detection pattern. At operation 1325, the audit event data is stored in an audit results data structure (e.g., in the storage 160 as described in FIG. 1, etc.). At operation 1330, a notification of the audit event is transmitted to an owner of the data stream. In an example, the notification includes an identity of the data stream, remediation steps, and a type of the audit event.

In an example, a connection is established to a configuration management database, a firewall log, and a data stream platform log. An enhanced audit event entry is generated that includes the audit event data and correlated data from the configuration management database, the firewall log, and the data stream platform log. The enhanced audit event entry is stored in the audit results data structure. In an example, the owner of the data stream may be determined using the enhanced audit event entry.

In an example, a new data stream may be generated (e.g., by the data stream scrubber 155 as described in FIG. 1, etc.) by removing the sensitive data from the data stream and the new data stream is published to a data stream platform. In an example, a data consumer may be identified for the data stream and the data consumer may be redirected to the new data stream. For example, the social security numbers or other sensitive data may be removed from the data stream and published as a second data stream that has been scrubbed of sensitive data. The data consumer may be redirected to the new scrubbed data stream to prevent inadvertent release of sensitive data.

The enhanced audit event entry may be evaluated (e.g., by the artificial intelligence engine 165 as described in FIG. 1, etc.) using an artificial intelligence processor and the data detection pattern or the polling frequency may be adjusted based on the evaluation. In an example, the artificial intelligence processor may receive feedback in response to the notification transmitted to the owner of the data stream and may evaluate the response in combination with the enhanced audit event entry to learn to reduce false positive detection, improve criticality calculation, and improve polling frequency adjustment. The output of the artificial intelligence processor may be used to improve algorithms used to set polling frequency, detect violations, calculate criticality, correlate data, etc.

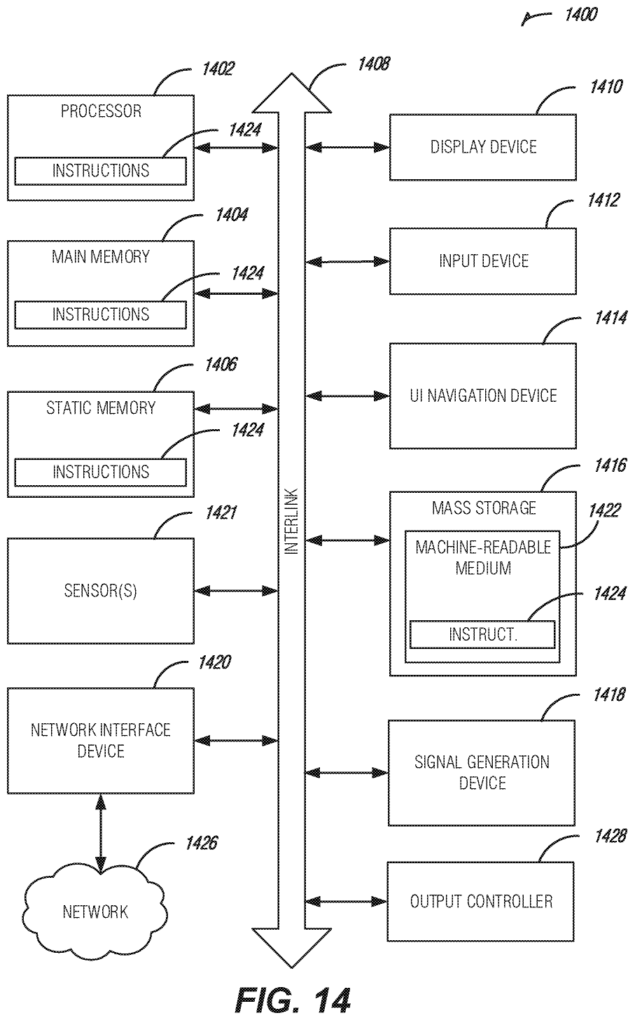

FIG. 14 illustrates a block diagram of an example machine 1400 upon which any one or more of the techniques (e.g., methodologies) discussed herein may perform. In alternative embodiments, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in peer-to-peer (P2P) (or other distributed) network environment. The machine 1400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1400 may include a hardware processor 1402 (e.g., a central processing unit (CPU), a graphics processing unit (GPU), a hardware processor core, or any combination thereof), a main memory 1404 and a static memory 1406, some or all of which may communicate with each other via an interlink (e.g., bus) 1408. The machine 1400 may further include a display unit 1410, an alphanumeric input device 1412 (e.g., a keyboard), and a user interface (UI) navigation device 1414 (e.g., a mouse). In an example, the display unit 1410, input device 1412 and UI navigation device 1414 may be a touch screen display. The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or other sensors. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1416 may include a machine readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or within the hardware processor 1402 during execution thereof by the machine 1400. In an example, one or any combination of the hardware processor 1402, the main memory 1404, the static memory 1406, or the storage device 1416 may constitute machine readable media.

While the machine readable medium 1422 is illustrated as a single medium, the term “machine readable medium” may include a single medium or multiple media (e.g., a centralized or distributed database, and/or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may further be transmitted or received over a communications network 1426 using a transmission medium via the network interface device 1420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1400, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for data stream auditing comprising:
at least one processor; and
memory including instructions that, when executed by the at least one processor, cause the at least one processor to perform operations to:
subscribe to a data stream;
collect data from the data stream, wherein the data is collected by polling the data stream at a polling frequency;
identify sensitive data in the collected data as an audit event;
generate audit event data;
store the audit event data in an audit results data structure;
transmit a notification of the audit event to an owner of the data stream;
in response to transmission of the notification, generate a scrubbed data stream by removing the sensitive data from the data stream;
publish the scrubbed data stream, the scrubbed data stream being a different data stream than the data stream;
in response to detection of an incoming request from a data consumer for data from the data stream, redirect the data consumer from the data stream to the scrubbed data stream, based on an access level of the data consumer, to return the data without the sensitive data; and
in response to receipt of feedback data, evaluate the feedback data using an artificial intelligence processor to adjust the polling frequency for the data stream.

2. The system of claim 1, the memory further comprising instructions that, when executed by the at least one processor, cause the at least one processor to perform operations to:
determine a criticality value for the data stream; and
adjust the polling frequency based on the criticality value.

3. The system of claim 1, wherein the data stream is subscribed to silently without interfering with a data consumer of the data stream.

4. The system of claim 1, the instructions to identify the sensitive data in the collected data further comprising instructions that, when executed by the at least one processor, cause the at least one processor to perform operations to:
obtain a data detection pattern from a data detection pattern data source; and
evaluate the collected data using the data detection pattern, wherein the sensitive data is identified based on a match between the collected data and the data detection pattern.

5. The system of claim 1, the memory further comprising instructions that, when executed by the at least one processor, cause the at least one processor to perform operations to:
establish a connection to a configuration management database, a firewall log, and a data stream platform log;
generate an enhanced audit event entry that includes the audit event data and correlated data from the configuration management database, the firewall log, and the data stream platform log;
store the enhanced audit event entry in the audit results data structure; and
wherein the owner of the data stream is determined using the enhanced audit event entry.

6. The system of claim 5, the memory further comprising instructions that, when executed by the at least one processor, cause the at least one processor to perform operations to:
evaluate the enhanced audit event entry using the artificial intelligence processor; and
refine a data detection pattern or the polling frequency based on the evaluation.

7. The system of claim 1, wherein the notification includes an identity of the data stream, remediation steps, and a type of the audit event.

8. The system of claim 1, the memory further comprising instructions that, when executed by the at least one processor, cause the at least one processor to perform operations to:
generate a new data stream by removing the sensitive data from the data stream;
publish the new data stream to a data stream platform;
identify a data consumer for the data stream; and
redirect the data consumer to the new data stream.

9. At least one non-transitory machine-readable medium including instructions for data stream auditing that, when executed by at least one processor, cause the at least one processor to perform operations to:
subscribe to a data stream;
collect data from the data stream, wherein the data is collected by polling the data stream at a polling frequency;
identify sensitive data in the collected data as an audit event;
generate audit event data;
store the audit event data in an audit results data structure;
transmit a notification of the audit event to an owner of the data stream;
in response to transmission of the notification, generate a scrubbed data stream by removing the sensitive data from the data stream;
publish the scrubbed data stream, the scrubbed data stream being a different data stream than the data stream;
in response to detection of an incoming request from a data consumer for data from the data stream, redirect the data consumer from the data stream to the scrubbed data stream, based on an access level of the data consumer, to return the data without the sensitive data; and
in response to receipt of feedback data, evaluate the feedback data using an artificial intelligence processor to adjust the polling frequency for the data stream.

10. The at least one non-transitory machine-readable medium of claim 9, further comprising instructions that, when executed by the at least one processor, cause the at least one processor to perform operations to:
determine a criticality value for the data stream; and
adjust the polling frequency based on the criticality value.

11. The at least one non-transitory machine-readable medium of claim 9, wherein the data stream is subscribed to silently without interfering with a data consumer of the data stream.

12. The at least one non-transitory machine-readable medium of claim 9, the instructions to identify the sensitive data in the collected data further comprising instructions that, when executed by the at least one processor, cause the at least one processor to perform operations to:
obtain a data detection pattern from a data detection pattern data source; and
evaluate the collected data using the data detection pattern, wherein the sensitive data is identified based on a match between the collected data and the data detection pattern.

13. The at least one non-transitory machine-readable medium of claim 9, further comprising instructions that, when executed by the at least one processor, cause the at least one processor to perform operations to:
establish a connection to a configuration management database, a firewall log, and a data stream platform log;
generate an enhanced audit event entry that includes the audit event data and correlated data from the configuration management database, the firewall log, and the data stream platform log;
store the enhanced audit event entry in the audit results data structure; and
wherein the owner of the data stream is determined using the enhanced audit event entry.

14. The at least one non-transitory machine-readable medium of claim 13, further comprising instructions that, when executed by the at least one processor, cause the at least one processor to perform operations to:
evaluate the enhanced audit event entry using the artificial intelligence processor; and
refine a data detection pattern or the polling frequency based on the evaluation.

15. The at least one non-transitory machine-readable medium of claim 9, wherein the notification includes an identity of the data stream, remediation steps, and a type of the audit event.

16. The at least one non-transitory machine-readable medium of claim 9, further comprising instructions that, when executed by the at least one processor, cause the at least one processor to perform operations to:
generate a new data stream by removing the sensitive data from the data stream;
publish the new data stream to a data stream platform;
identify a data consumer for the data stream; and
redirect the data consumer to the new data stream.

17. A method for data stream auditing comprising:
subscribing to a data stream;
collecting data from the data stream, wherein the data is collected by polling the data stream at a polling frequency;
identifying sensitive data in the collected data as an audit event;
generating audit event data;
storing the audit event data in an audit results data structure;
transmitting a notification of the audit event to an owner of the data stream;
in response to transmitting the notification, generating a scrubbed data stream by removing the sensitive data from the data stream;
publishing the scrubbed data stream, the scrubbed data stream being a different data stream than the data stream;
in response to detection of an incoming request from a data consumer for data from the data stream, redirecting the data consumer from the data stream to the scrubbed data stream, based on an access level of the data consumer, to return the data without the sensitive data; and
in response to receipt of feedback data, evaluate the feedback data using an artificial intelligence processor to adjust the polling frequency for the data stream.

18. The method of claim 17, further comprising:
determining a criticality value for the data stream; and
adjusting the polling frequency based on the criticality value.

19. The method of claim 17, wherein the data stream is subscribed to silently without interfering with a data consumer of the data stream.

20. The method of claim 17, identifying the sensitive data in the collected data further comprising:
obtaining a data detection pattern from a data detection pattern data source; and
evaluating the collected data using the data detection pattern, wherein the sensitive data is identified based on a match between the collected data and the data detection pattern.

21. The method of claim 17, further comprising:
establishing a connection to a configuration management database, a firewall log, and a data stream platform log;
generating an enhanced audit event entry that includes the audit event data and correlated data from the configuration management database, the firewall log, and the data stream platform log;
storing the enhanced audit event entry in the audit results data structure; and
wherein the owner of the data stream is determined using the enhanced audit event entry.

22. The method of claim 21, further comprising:
evaluating the enhanced audit event entry using the artificial intelligence processor; and
refining a data detection pattern or the polling frequency based on the evaluation.

23. The method of claim 17, wherein the notification includes an identity of the data stream, remediation steps, and a type of the audit event.

24. The method of claim 17, further comprising:
generating a new data stream by removing the sensitive data from the data stream;
publishing the new data stream to a data stream platform;
identifying a data consumer for the data stream; and
redirecting the data consumer to the new data stream.
